(19) United States
(12) Patent Application Publication
(10) Pub. No.: US 2023/0339214 A1
(43) Pub. Date: Oct. 26, 2023

(54) GLASS-GLASS LAMINATE AND METHOD OF MANUFACTURING AND CUTTING THE SAME

(71) Applicant: CORNING INCORPORATED, CORNING, NY (US)

(72) Inventors: Joseph Ahn, Asan-Si (KR); Jae-seon Hong, Uiwang-si (KR); Goo Soo Lee, Songpa-gu (KR); Hyung Soo Moon, Seoul (KR); Seung-yong Park, Asan-si (KR)

(21) Appl. No.: 18/027,285

(22) PCT Filed: Sep. 17, 2021
(86) PCT No.: PCT/US2021/050768

§ 371 Date: Mar. 20, 2023

(30) Foreign Application Priority Data
Sep. 21, 2020 (KR) 10-2020-0121787
Jun. 2, 2021 (KR) 10-2021-0071586

(51) Int. Cl. B32B 17/10; B32B 7/12; B32B 37/12

(52) U.S. Cl. CPC B32B 17/10256; B32B 7/12; B32B 17/10119; B32B 37/12; B32B 2250/05; B32B 2037/1253; B32B 2307/7376

(57) ABSTRACT

Disclosed are glass-glass laminates. A glass-glass laminate includes: a lower glass layer; an adhesive layer on the lower glass layer; an upper glass layer on the adhesive layer; and a decoration layer between the lower glass layer and the adhesive layer or between the upper glass layer and the adhesive layer, wherein the thickness of the upper glass layer is less than the thickness of the lower glass layer, and the thermal expansion coefficient of the upper glass layer is less than the thermal expansion coefficient of the lower glass layer.

### CROSS-REFERENCE TO RELATED APPLICATION

This application is based on and claims priority under 35 U.S.C. § 119 to Korean Patent Application No. 10-2020-0121787, filed on Sep. 21, 2020, in the Korean Intellectual Property Office, and also claims priority to Korean Patent Application No. 10-2021-0071586, filed Jun. 2, 2021, in the Korean Intellectual Property Office, the disclosure of each of which is incorporated by reference herein in its entirety.

### BACKGROUND

### 1. Field

One or more embodiments relates to glass laminates, manufacturing methods thereof, and cutting methods thereof, and more particularly, to glass-glass laminates to which glass is bonded, manufacturing methods thereof, and cutting methods thereof.

### 2. Description of the Related Art

Glass laminates include a substrate, a glass layer, and an adhesive layer for bonding the glass layer to the substrate. Glass has superior scratch resistance, chemical durability, and aesthetic beauty to polymers such as polyethylene terephthalate (PET) or poly vinyl chloride (PVC). A high pressure laminate (HPL), a medium density fiberboard (MDF), steel, and the like can be used as a material for the substrate of a glass laminate. However, glass laminates containing HPL and MDF are susceptible to humidity changes, and glass laminates containing steel are susceptible to temperature changes due to a difference in the thermal expansion coefficient between steel and glass.

### SUMMARY

One or more embodiments include glass-glass laminates that have excellent durability, do not require a high-temperature process for manufacturing, and are easy to cut and process.

Additional aspects will be set forth in part in the description which follows and, in part, will be apparent from the description, or may be learned by practice of the presented embodiments of the disclosure.

According to one or more embodiments, a glass-glass laminate includes a lower glass layer, an adhesive layer on the lower glass layer, an upper glass layer on the adhesive layer, and a decoration layer between the lower glass layer and the adhesive layer or between the upper glass layer and the adhesive layer, wherein the thickness of the upper glass layer is less than the thickness of the lower glass layer, and the thermal expansion coefficient of the upper glass layer is less than the thermal expansion coefficient of the lower glass layer.

In some embodiments, the lower glass layer may include soda lime glass, and the upper glass layer may include at least one of borosilicate glass or aluminosilicate glass.

In some embodiments, the thickness of the upper glass layer may be about 0.1 mm to about 1.5 mm.

In some embodiments, the adhesive layer may include a room-temperature adhesive material.

In some embodiments, the absolute value of bow of the upper glass layer may be about 0 μm to about 500 μm.

In some embodiments, the thickness of the lower glass layer may be about 0.1 mm to about 17 mm.

In some embodiments, the thickness of the lower glass layer may be about 0.4 mm to about 12 mm.

In some embodiments, the decoration layer may be in direct contact with the lower glass layer or the upper glass layer.

In some embodiments, the room-temperature adhesive material may include a pressure sensitive adhesive (PSA) or an optically clear adhesive (OCA).

In some embodiments, the thickness of the adhesive layer may be about 10 μm to about 500 μm.

In some embodiments, the thickness of the adhesive layer may be about 50 μm to about 300 μm.

In some embodiments, the room-temperature adhesive material may include an ultraviolet curing material.

According to one or more embodiments, a glass-glass laminate includes a lower glass layer, an adhesive layer on the lower glass layer, an upper glass layer on the adhesive layer, and a decoration layer between the lower glass layer and the adhesive layer or between the upper glass layer and the adhesive layer, wherein the adhesive layer includes a room-temperature adhesive material.

According to one or more embodiments, a glass-glass laminate includes a first glass layer, a first adhesive layer on the first glass layer, a second glass layer on the first adhesive layer, a second adhesive layer on the second glass layer, a third glass layer on the second adhesive layer, a first decoration layer between the first glass layer and the first adhesive layer or between the second glass layer and the first adhesive layer, and a second decoration layer between the second glass layer and the second adhesive layer or between the third glass layer and the second adhesive layer, wherein the first adhesive layer and the second adhesive layer each include a room-temperature adhesive material.

According to one or more embodiments, a method of manufacturing a glass-glass laminate includes forming a decoration layer on an upper glass layer or a lower glass layer, bonding, to the lower glass layer, an adhesive layer including a room-temperature adhesive material, and bonding the upper glass layer to the adhesive layer.

In some embodiments, the bonding of the upper glass layer to the adhesive layer may be performed at a temperature higher than room temperature.

In some embodiments, the forming of the decoration layer may include printing the decoration layer on the upper glass layer or the lower glass layer.

In some embodiments, the room-temperature adhesive material may include a pressure sensitive adhesive (PSA) or an optically clear adhesive (OCA).

According to one or more embodiments, a method of manufacturing a glass-glass laminate includes forming a decoration layer on an upper glass layer or a lower glass layer, applying an ultraviolet curing adhesive material in a liquid state to the lower glass layer, bonding the upper glass layer to the ultraviolet curing adhesive material, and forming an adhesive layer by curing the ultraviolet curing adhesive material.

In some embodiments, the bonding of the upper glass layer to the ultraviolet curing adhesive material may be performed at a temperature higher than room temperature.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of a glass-glass laminate according to one or more embodiments;

FIG. 2 is a graph of a simulation result showing bow of the present embodiment and Comparative Examples 1 to 5;

FIG. 3A illustrates a simulation result showing stress generated in a glass-glass laminate according to an embodiment;

FIGS. 3B to 3F illustrate simulation results showing stress generated in glass-glass laminates according to Comparative Examples 1 to 5, respectively;

FIG. 4 is a cross-sectional view of a glass-glass laminate according to one or more embodiments;

FIG. 5 is a cross-sectional view of a glass-glass laminate according to one or more embodiments;

FIG. 6 is a cross-sectional view of a glass-glass laminate according to one or more embodiments;

FIG. 7 is a cross-sectional view of a glass-glass laminate according to one or more embodiments;

FIG. 8 is a cross-sectional view of a glass-glass laminate according to one or more embodiments;

FIG. 9 is a cross-sectional view of a glass-glass laminate according to one or more embodiments;

FIG. 10 is a cross-sectional view of a glass-glass laminate according to one or more embodiments;

FIG. 11 is a flowchart of a method of manufacturing a glass-glass laminate, according to one or more embodiments;

FIGS. 12A to 12C are cross-sectional views showing the method of FIG. 11

FIG. 13 is a flowchart of a method of manufacturing a glass-glass laminate, according to one or more embodiments;

FIGS. 14A to 14C are cross-sectional views showing the method of FIG. 13

FIG. 15 is a flowchart of a method of cutting a glass-glass laminate according to one or more embodiments;

FIGS. 16A to 16C are cross-sectional views showing the method of FIG. 15

FIG. 17A is a cross-sectional view of a bow measuring method; and

FIG. 17B is a plan view of the bow measuring method.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, exemplary embodiments will be described in detail with reference to the accompanying drawings. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. Throughout the drawings, like reference numerals denote like elements. Furthermore, various components and regions in the drawings are schematically illustrated. Accordingly, the present invention is not limited by the relative size or distance drawn in the accompanying drawings.

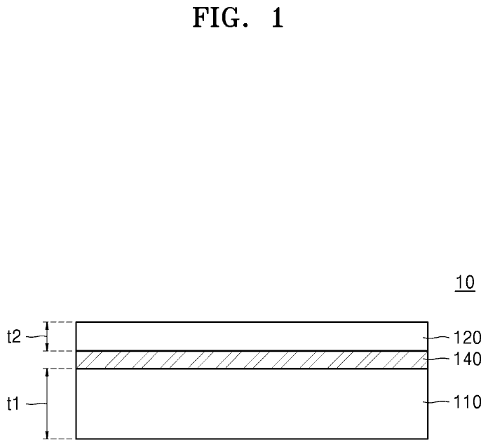

FIG. 1 is a cross-sectional view of a glass-glass laminate 10 according to one or more embodiments.

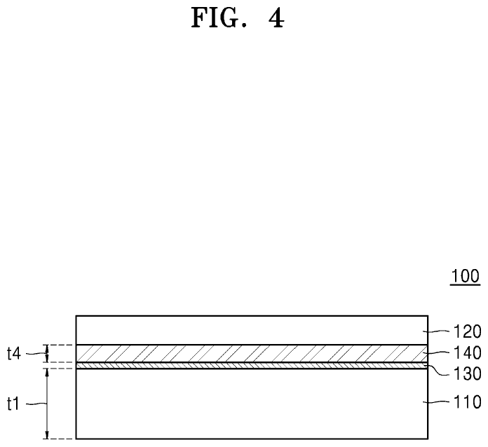

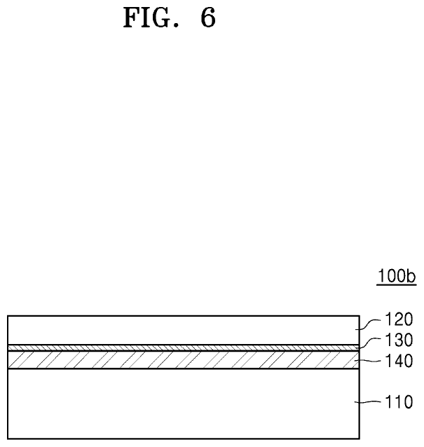

Referring to FIG. 1, the glass-glass laminate 10 may include a lower glass layer 110, an adhesive layer 140 on the lower glass layer 110, and an upper glass layer 120 on the adhesive layer 140. As it will be described in more detail below with reference to FIGS. 4 and 6, the glass-glass laminate 10 may further include a decoration layer (not shown) between the lower glass layer 110 and the adhesive layer 140 or between the upper glass layer 120 and the adhesive layer 140. The decoration layer may be printed on or attached to the lower glass layer 110 or the upper glass layer 120.

The lower glass layer 110 and the upper glass layer 120 may include certain glass including soda lime glass, aluminosilicate glass, borosilicate glass, aluminoborosilicate glass, alkali-aluminosilicate glass, alkali-borosilicate glass, or alkali-aluminoborosilicate glass. The adhesive layer 140 may include a certain material capable of attaching the lower glass layer 110 to the upper glass layer 120.

In some embodiments, a thickness t2 of the upper glass layer 120 may be less than a thickness t1 of the lower glass layer 110. Using the upper glass layer 120 that is a relatively thin may improve aesthetics, and using the lower glass layer 110 that is relatively thick may provide sufficient mechanical support.

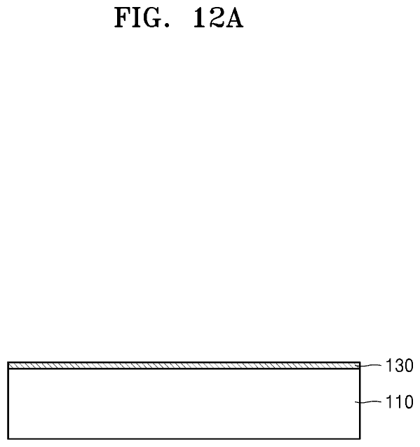

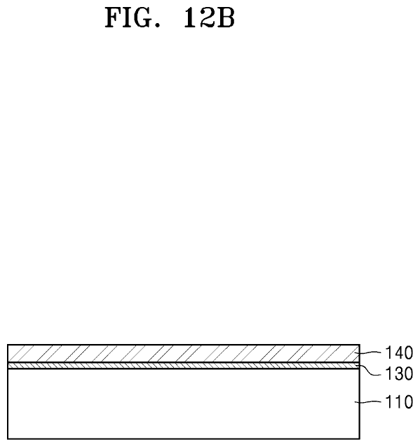

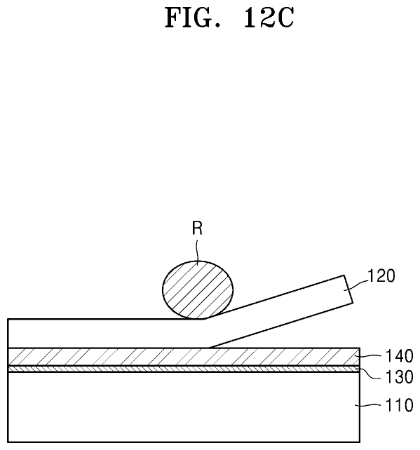

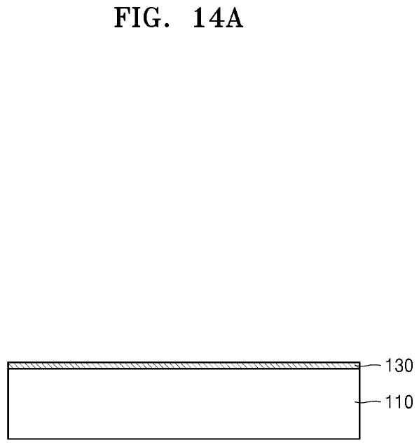

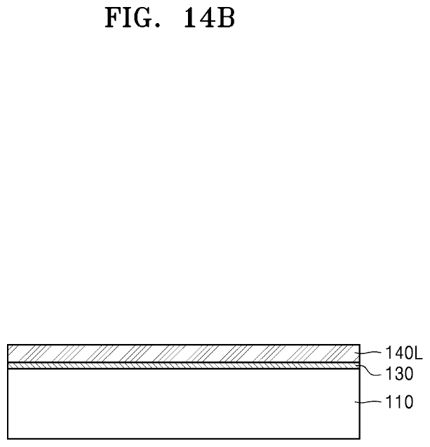

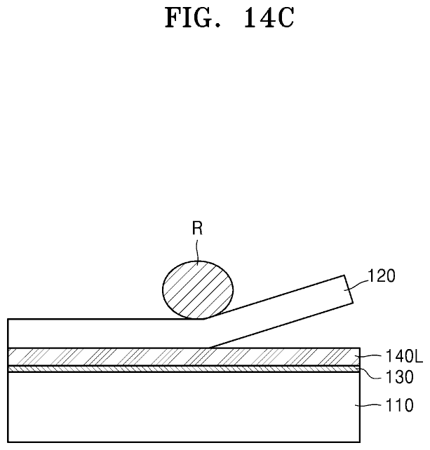

In some embodiments, the thickness t2 of the upper glass layer 120 may be about 0.1 mm to about 1.5 mm. When the thickness t2 of the upper glass layer 120 is less than about 0.1 mm, the upper glass layer 120 is so thin that sufficient mechanical support may not be provided to the glass-glass laminate 10, and thus it may be difficult to manufacture the glass-glass laminate 10. When the thickness t2 of the upper glass layer 120 exceeds about 1.5 mm, the upper glass layer 120 is so thick that the upper glass layer 120 may not be bent when the upper glass layer 120 is attached to the lower glass layer 110 (see FIGS. 12C and 14C). Accordingly, when the thickness t2 of the upper glass layer 120 exceeds about 1.5 mm, it may be difficult to manufacture the glass-glass laminate 10.

In some embodiments, a thermal expansion coefficient of the upper glass layer 120 may be less than a thermal expansion coefficient of the lower glass layer 110. When the upper glass layer 120 is attached to the lower glass layer 110 at a temperature, for example, about 35° C. to about 40° C., which is slightly higher than room temperature, for example, about 20° C. to about 25° C., slight compression stress may be generated in the upper glass layer 120 that is relatively thin, at room temperature. Accordingly, damage to the upper glass layer 120 that is relatively thin may be prevented during processing, transport, or storage. Accordingly, durability of the glass-glass laminate 10 may be improved.

The composition of the upper glass layer 120 and the composition of the lower glass layer 110 may be different from each other so that the upper glass layer 120 and the lower glass layer 110 have different thermal expansion coefficients. In some embodiments, the lower glass layer 110 may include soda lime glass, and the upper glass layer 120 may include at least one of borosilicate glass or aluminosilicate glass. For example, the upper glass layer 120 may include Willow® glass or Eagle XG® glass that is borosilicate glass and obtainable from Corning Incorporated, or Gorilla® glass that is aluminosilicate glass and obtainable from Corning Incorporated. Approximately, the thermal expansion coefficient of soda lime glass may be about 8.6 ppm/° C., the thermal expansion coefficient of Willow® glass may be about 3.46 ppm/° C., the thermal expansion coefficient of Eagle XG® glass may be about 3.17 ppm/° C., and the thermal expansion coefficient of Gorilla® glass may be about 7.586 ppm/° C. The thermal expansion coefficients may be measured by ISO 7991:1987.

### EXPERIMENTAL EXAMPLE

Under four environment conditions, bows of a glass-glass laminate and glass-nonglass laminates are measured, and thus long-term reliability of the glass-glass laminate and the glass-nonglass laminates are evaluated. The glass-nonglass laminates may have a structure including a nonglass layer, an adhesive layer, and an upper glass layer. For example, a glass-steel laminate may include a steel layer, an adhesive layer, and an upper glass layer. Furthermore, a glass-steel-MDF laminate may include a glass layer, a first adhesive layer, a steel layer, a second adhesive layer, an MDF layer, a third adhesive layer, and an upper glass layer. Furthermore, a glass-HPL laminate may include a HPL layer, an adhesive layer, and an upper glass layer.

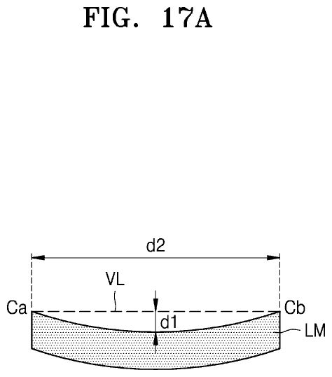

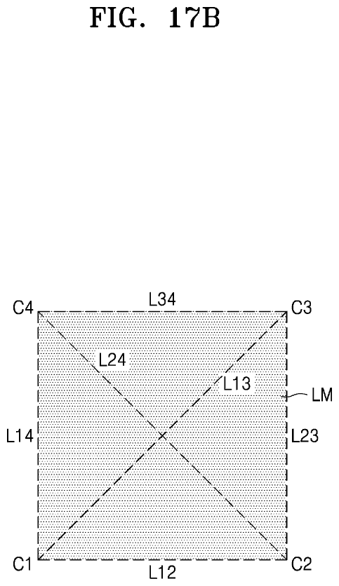

FIG. 17A is a cross-sectional view of a bow measuring method. FIG. 17B is a plan view of a bow measuring method. Referring to FIGS. 17A and 17B, bow according to a virtual straight line VL between two corners Ca and Cb of a laminate LM may be defined by dividing a maximum distance d1 from a virtual straight line between the two corners Ca and Cb of the laminate LM to a surface of the laminate LM by a length d2 of the virtual straight line between the two corners Ca and Cb (bow=d1/d2). When the laminate LM has four corners C1, C2, C3, and C4, as illustrated in FIG. 17B, six bows (d1/d2) may be measured along each of a first virtual line L12 between a first corner C1 and a second corner C2, a second virtual line L23 between the second corner C2 and a third corner C3, a third virtual line L34 between the third corner C3 and a fourth corner C4, a fourth virtual line L14 between the fourth corner C4 and the first corner C1, a fifth virtual line L13 between the first corner C1 and the third corner C3, and a sixth virtual line L24 between the second corner C2 and the fourth corner C4. The maximum value among the six bows (d1/d2) may be defined to be the bow of the laminate LM.

The four environment conditions are summarized in Table 1 below, and a bow measurement result is summarized in Table 2 below.

TABLE 1

| | |
|---|---|
| Environment Condition #1 | 60° C., 30 days |
| Environment Condition #2 | 30° C., 90% RH, 30 days |
| Environment Condition #3 | 30° C., 30% RH, 30 days |
| Environment Condition #4 | 60° C., 11 hours <−> −40° C. |
| | 11 hours, 1 hour ramp-up, 14 cycles |

TABLE 2

| | Bow (mm/m) | | | |
|---|---|---|---|---|
| | Environment | Environment | Environment | Environment |
| | Condition #1 | Condition #2 | Condition #3 | Condition #4 |
| Glass-Glass | 1.1 | 1.67 | 0.55 | 1.1 |
| Laminate | | | | |
| Glass-Steel | N/A | N/A | N/A | N/A |
| Laminate | | | | |
| Glass-Steel- | 8.8 | 13.3 | 2.2 | Broken |
| MDF | | | | |
| Laminate | | | | |
| Glass-HPL | 5.5 | 7.8 | 1.1 | 2.33 |
| Laminate | | | | |

Referring to Table 2 above, it was impossible to measure the bow of a glass-steel laminate because steel does not provide a sufficient mechanical strength to measure bow. Furthermore, under Environment Condition #4, it was impossible to measure the bow of a glass-steel-MDF laminate because cracks were generated at an edge of the glass-steel-MDF laminate. Under all environment conditions, the bow of a glass-glass laminate was less than the bows of a glass-steel-MDF laminate and a glass-HPL laminate. In other words, it was evaluated that the glass-glass laminate has excellent reliability to temperature and humidity changes, compared with the glass-nonglass laminate.

### SIMULATION EXAMPLE

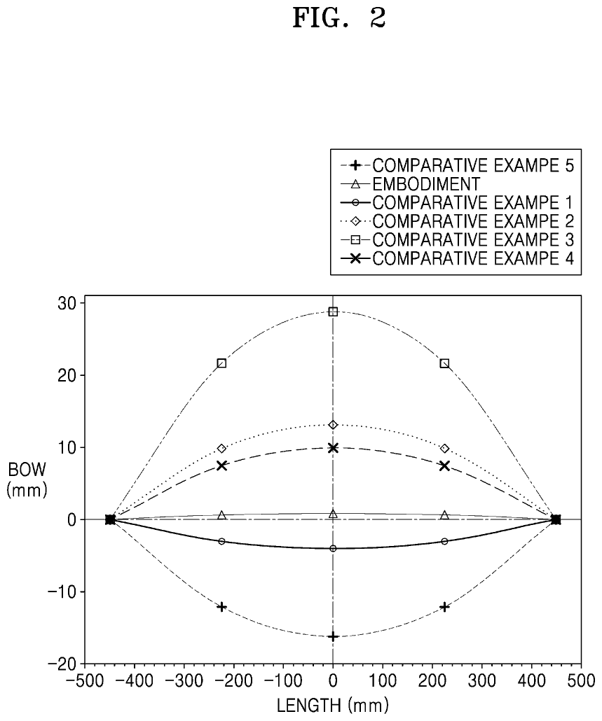

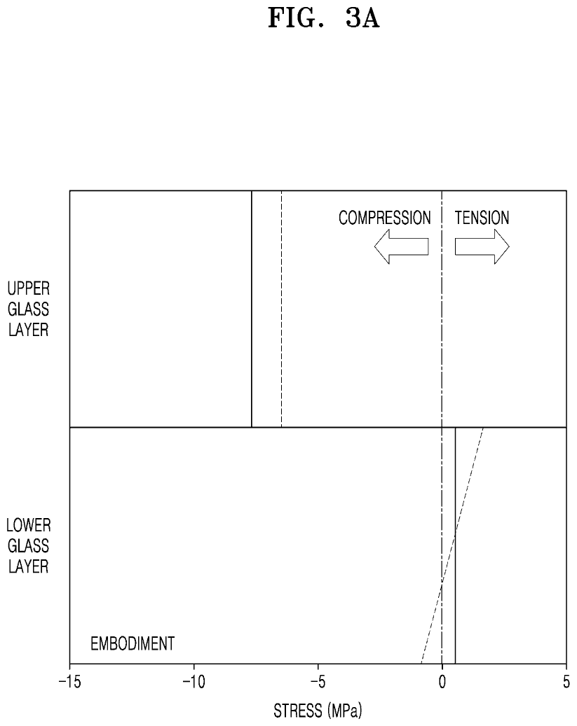

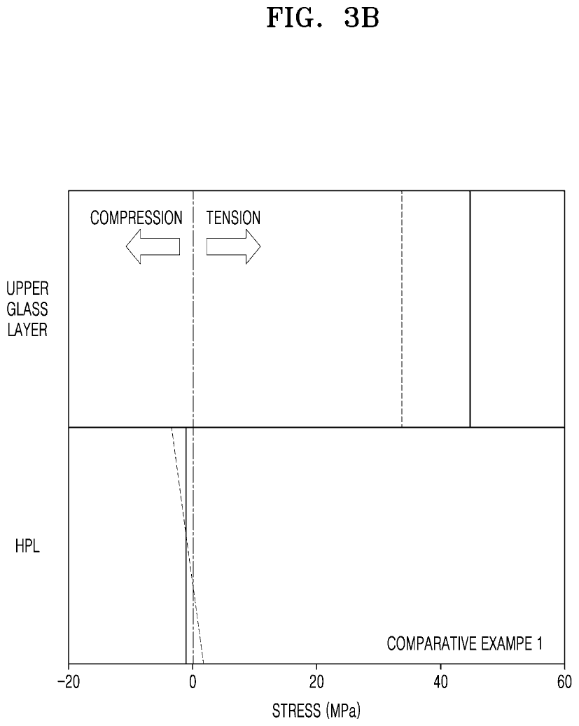

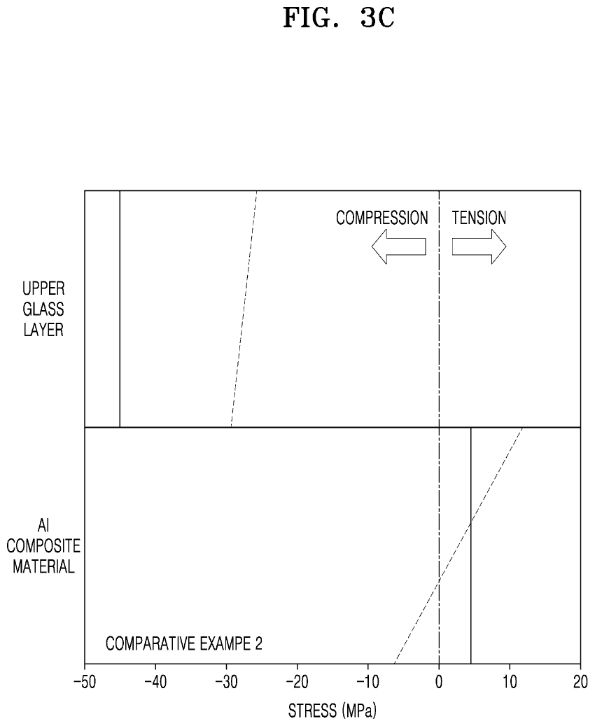

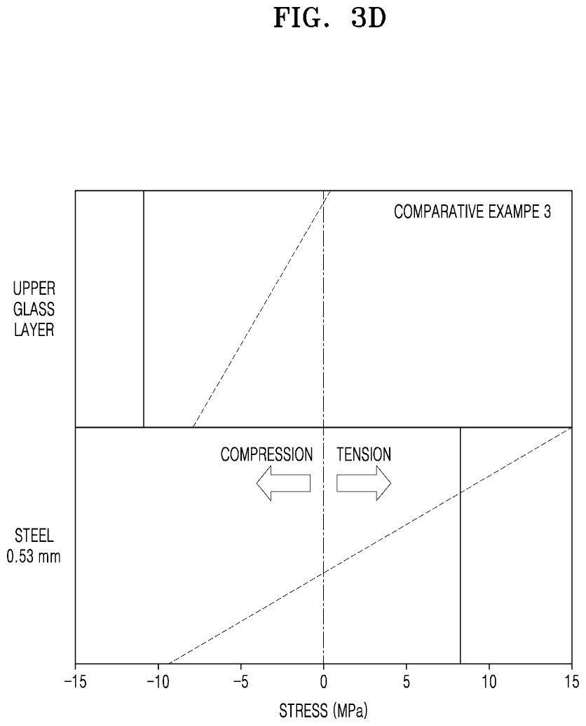

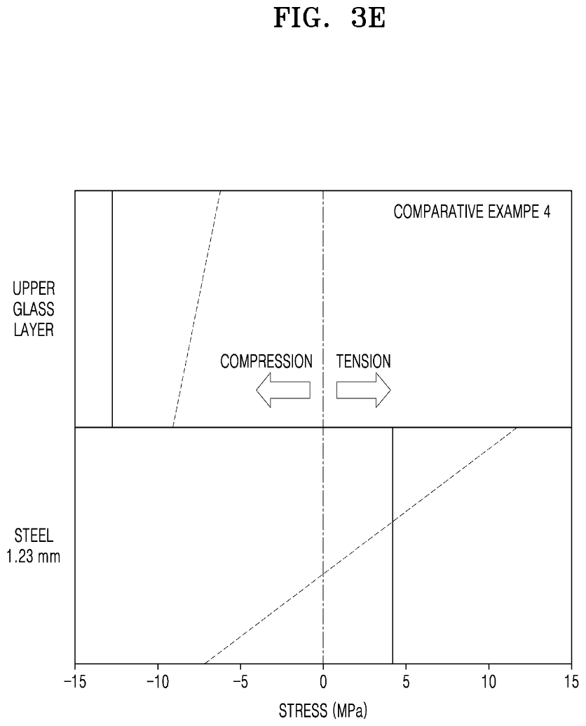

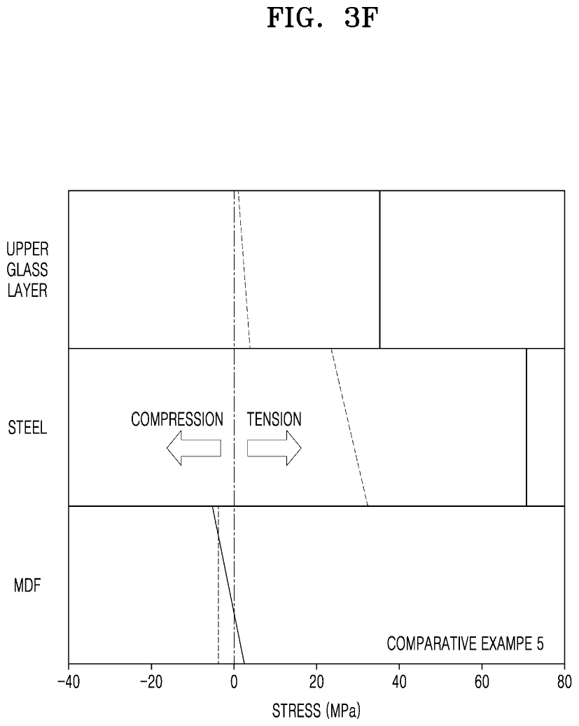

Under conditions of a temperature of 0 to 35° C. and a humidity of 20 to 80% RH, bow, edge stress, bow stiffness (flexural rigidity), curvature, and radius of each of Embodiment (a glass-glass laminate), Comparative Example 1 (a glass-HPL laminate), Comparative Example 2 (glass-Al composite material), Comparative Example 3 (a glass-(0.53 mm steel) laminate), Comparative Example 4 (a glass-(1.23 mm steel) laminate), and Comparative Example 5 (a glass-steel-MDF laminate), each having a size of 900 mm×900 mm , were calculated. A simulation result is summarized in Table 3 below. Furthermore, FIG. 2 illustrates a simulation result showing bows of Embodiment and Comparative Examples 1 to 5, each having a size of 900 mm×900 mm, under the temperature and humidity conditions. Furthermore, FIG. 3A illustrates a simulation result showing stress generated in Embodiment having a size of 900 mm×900 mm, under the temperature and humidity conditions. Furthermore, FIGS. 3B to 3F illustrate simulation result showing stress generated in Comparative Examples 1 to 5, each having a size of 900 mm×900 mm, under the temperature and humidity conditions.

TABLE 3

| | | | | Bow | | |
|---|---|---|---|---|---|---|
| | | Edge Stress | | Stiffness | | |
| | Bow | (MPa) | | (×10⁶) | Curvature | Radius |
| | (mm) | (Fixed) | (Free) | MPa · mm⁴ | (m⁻¹) | (m) |
| Embodiment | 0.9 | −7.7 | −6.3 | 410.4 | 0.009 | 115.9 |
| Comparative | −4.1 | 44.6 | 33.3 | 796.1 | −0.040 | −24.8 |
| Example 1 | | | | | | |
| Comparative | 13.1 | −45.0 | −25.6 | 240.3 | 0.130 | 7.7 |
| Example 2 | | | | | | |
| Comparative | 28.6 | −10.9 | 0.5 | 3.3 | 0.283 | 3.5 |
| Example 3 | | | | | | |
| Comparative | 9.9 | −12.8 | −6.2 | 27.4 | 0.098 | 10.2 |
| Example 4 | | | | | | |
| Comparative | −16.2 | 35.3 | 0.8 | 1621.3 | −0.160 | −6.2 |
| Example 5 | | | | | | |

In Table 3 above, edge stress (Fixed) represents the edge stress calculated under the condition that the edges of different layers are fixed to each other, and edge stress (free) represents the edge stress calculated under the condition that the edges of different layers are movable with respect to each other. Solid lines in FIGS. 3A to 3F represent the stresses calculated under the condition that the edges of different layers are fixed to each other. Dashed lines in FIGS. 3A to 3F represent the stresses calculated under the condition that the edges of different layers are movable to each other

Referring to Table 3, Comparative Example 1 including HPL shows positive edge stress, that is, tensile stress. Referring to FIG. 3B, tensile stress is formed in the upper glass layer of Comparative Example 1. Likewise, referring to Table 3, Comparative Example 5 including MDF shows positive edge stress, that is, tensile stress. Referring to FIG. 3F, tensile stress is formed in the upper glass layer of Comparative Example 5. Accordingly, in Comparative Example 1 and Comparative Example 5, the relatively thin upper glass layers may be easily damaged.

Referring to Table 3, Comparative Example 2 including an Al composite material, Comparative Example 3 including 0.53 mm steel, and Comparative Example 4 including 1.23 mm steel show negative edge stress, that is, compression stress. Referring to FIGS. 3C to 3E, compression stress is formed in the upper glass layers of Comparative Examples 2 to 4. However, referring to FIG. 2 and Table 3, the absolute values of the bows of Comparative Examples 2 to 5 are much greater than the absolute value of the bow of Embodiment.

Referring to Table 3, Embodiment shows slight negative edge stress, that is, compression stress. Referring to FIG. 3A, slight compression stress is formed in the upper glass layer of Embodiment. Accordingly, damage of a relatively thin upper glass layer of Embodiment may be prevented. Referring to FIG. 2 and Table 3, the absolute value of the bow of Embodiment is less than the absolute values of the bows of Comparative Example 1 to 5. In other words, Embodiment is less deformed by the temperature and humidity changes than Comparative Example 1 to 5.

FIG. 4 is a cross-sectional view of a glass-glass laminate 100 according to one or more embodiments. In the following description, a difference between the glass-glass laminate 10 of FIG. 1 and the glass-glass laminate 100 of FIG. 4 is mainly described.

The glass-glass laminate 100 may further include a decoration layer 130 between the lower glass layer 110 and the adhesive layer 140. The decoration layer 130 may be printed on the lower glass layer 110. Accordingly, the decoration layer 130 may be in direction contact with the lower glass layer 110. In other words, an additional adhesive layer may be unnecessary between the decoration layer 130 and the lower glass layer 110. The decoration layer 130 may be formed on the lower glass layer 110 to improve aesthetics of the glass-glass laminate 100. The decoration layer 130 may represent various colors, textures, and/or images. In some embodiments, the decoration layer 130 may be a layer formed by inkjet printing that is relatively susceptible to heat.

In some embodiments, the thickness t1 of the lower glass layer 110 may be about 0.1 mm to about 17 mm. When the thickness t1 of the lower glass layer 110 is less than about 0.1 mm, the lower glass layer 110 is so thin that sufficient mechanical support may not be provided to the glass-glass laminate 100, and thus it may be difficult to manufacture the glass-glass laminate 100. When the thickness t1 of the lower glass layer 110 exceeds 17 mm, the lower glass layer 110 is so thick that the cutting and processing of the glass-glass laminate 100 may be difficult. The thickness t1 of the lower glass layer 110 may be about 0.4 mm to about 12 mm.

The adhesive layer 140 may protect a room-temperature adhesive material. In glass-glass laminates according to related art, PVB is used to attach glasses. Heating is needed to attach glasses using PVB, and thus the decoration layer 130 may be deformed due to the heating, and excessive stress may be generated in the lower and upper glass layers 110 and 120. Furthermore, as a thermosetting PVB film is difficult to cut, the cutting of a glass-glass laminate is difficult.

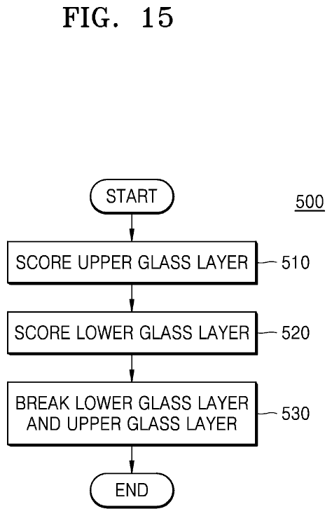

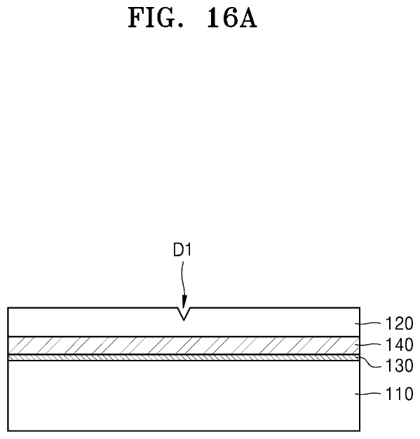

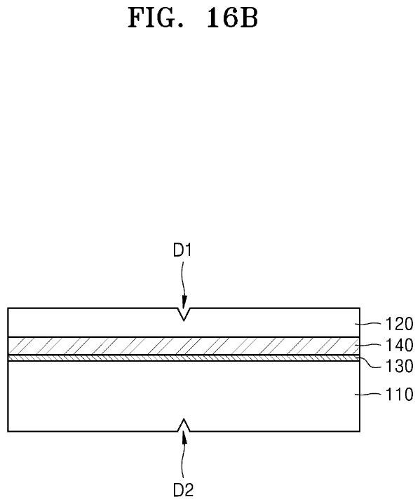

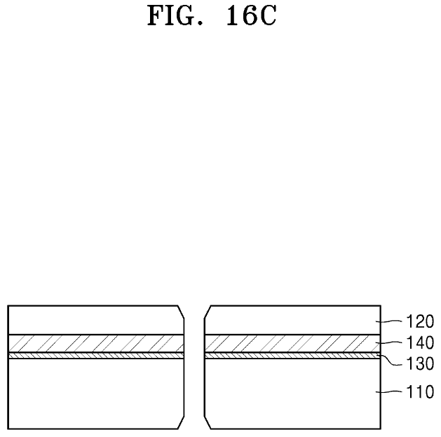

The glass-glass laminate 100 according to one or more embodiments may use a room-temperature adhesive material, instead of the thermosetting PVB film, as the adhesive layer 140. Accordingly, as a high temperature process is unnecessary for the manufacture of the glass-glass laminate 100, the deformation of the decoration layer 130 due to heat and the generation of excessive stress in the lower and upper glass layers 110 and 120 may be prevented. Furthermore, the cutting and processing of the glass-glass laminate 100 after manufacturing may be facilitated. For example, a glass-glass laminate according to one or more embodiments may be easily cut by a scoring-breaking cutting method that is described with reference to FIGS. 15 and 16A to 16C. Accordingly, the glass-glass laminate 100 according to one or more embodiments may be easily cut and processed at work site.

The room-temperature adhesive material may mean a certain material capable of attaching the lower and upper glass layers 110 and 120 without heating. The room-temperature adhesive material may include, for example, a sensitive adhesive (a pressure sensitive adhesive (PSA)), an optically clear adhesive (OCA), or an ultraviolet curing material.

When the room-temperature adhesive material includes PSA or OCA, a thickness t4 of the adhesive layer 140 may be about 10 μm to about 500 μm. When the thickness t4 of the adhesive layer 140 is less than about 10 μm, the adhesive layer 140 is so thin that the lower and upper glass layers 110 and 120 may be broken or air bubbles may be captured when the lower and upper glass layers 110 and 120 are attached to each other. When the thickness t4 of the adhesive layer 140 exceeds about 500 μm, the adhesive layer 140 is so thick that the cutting and processing of the glass-glass laminate 100 may be difficult. The thickness t4 of the adhesive layer 140 may be about 150 μm to about 300 μm. PSA and OCA may include, for example, an acryl-based material.

When the room-temperature adhesive material includes an ultraviolet curing material, the thickness t4 of the adhesive layer 140 may be about 150 μm or less. When the thickness t4 of the adhesive layer 140 exceeds 150 μm, over curing is generated in the upper portion of the adhesive layer 140 so that discoloration and deformation of the adhesive layer 140 may be generated. The thickness t4 of the adhesive layer 140 may be about 100 μm or less.

The ultraviolet curing material may include acryl resin, epoxy resin, or acrylic urethane resin. The ultraviolet curing material may include, for example, (meta)acrylate oligomer and a photoinitiator, monofunctional to bifunctional or more acryl monomer, and an adhesive enhancer. The (meta)acrylate oligomer may include, for example, polyurethane (meta)acrylate-based oligomer, polyester (meta)acrylate-based oligomer, acryl (meta)acrylate-based oligomer, or combinations thereof. In some embodiments, the ultraviolet curing material may have a viscosity of 100 to 8000 cps at 25° C. In some embodiments, the ultraviolet curing material may have a transmittance of 90% or more to improve aesthetics.

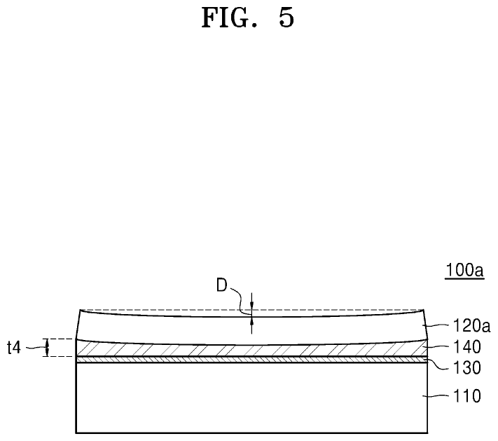

FIG. 5 is a cross-sectional view of a glass-glass laminate 100a according to one or more embodiments. In the following description, a difference between the glass-glass laminate 100 of FIG. 4 and the glass-glass laminate 100a of FIG. 5 is mainly described.

Referring to FIG. 5, the glass-glass laminate 100a may include the upper glass layer 120a that is bent. The absolute value of a bow D of the upper glass layer 120a may be about 0 to about 500 μm. When the absolute value of the bow D of the upper glass layer 120a exceeds about 500 μm, and the adhesive layer 140 includes PSA or OCA, air bubbles may be generated. When the absolute value of the bow D of the upper glass layer 120a exceeds about 500 μm, and the adhesive layer 140 includes an ultraviolet curing material, the thickness of the adhesive layer 140 including an ultraviolet curing material increases so that part of the adhesive layer 140 is over cured so that discoloration of the adhesive layer 140 or deformation of the glass-glass laminate 100a may be generated. Furthermore, the adhesive layer 140 including an ultraviolet curing material, which is thick, may make the cutting and processing of the glass-glass laminate 100a difficult.

FIG. 6 is a cross-sectional view of a glass-glass laminate 100b according to one or more embodiments. In the following description, a difference between the glass-glass laminate 100 of FIG. 4 and the glass-glass laminate 100b of FIG. 6 is mainly described.

Referring to FIG. 6, the decoration layer 130 may be located between the adhesive layer 140 and the upper glass layer 120. In other words, the glass-glass laminate 100b may include the lower glass layer 110, the adhesive layer 140, the decoration layer 130, and the upper glass layer 120, which are sequentially stacked. The decoration layer 130 may be a layer printed on the upper glass layer 120. Accordingly, the decoration layer 130 may be in direct contact with the upper glass layer 120.

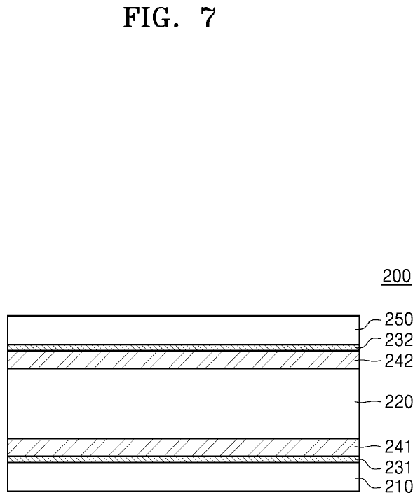

FIG. 7 is a cross-sectional view of a glass-glass laminate 200 according to one or more embodiments.

Referring to FIG. 7, the glass-glass laminate 200 may include a first glass layer 210, a first adhesive layer 241 on the first glass layer 210, a second glass layer 220 on the first adhesive layer 241, a second adhesive layer 242 on the second glass layer 220, a third glass layer 250 on the second adhesive layer 242, a first decoration layer 231 between the first glass layer 210 and the first adhesive layer 241, and a second decoration layer 232 between the second adhesive layer 242 and the third glass layer 250. In other words, the glass-glass laminate 200 may include the first glass layer 210, the first decoration layer 231, the first adhesive layer 241, the second glass layer 220, the second adhesive layer 242, the second decoration layer 232, and the third glass layer 250, which are sequentially stacked.

The first adhesive layer 241 may attach the first glass layer 210 to the second glass layer 220. The second adhesive layer 242 may attach the third glass layer 250 to the second glass layer 220. The first decoration layer 231 may be in direct contact with the first glass layer 210. The second decoration layer 232 may be in direct contact with the third glass layer 250.

As detailed descriptions of the first glass layer 210 and the third glass layer 250 are the same as those of the upper glass layer 120 of FIGS. 1 and 4, the descriptions thereof are omitted. As detailed descriptions of the first decoration layer 231 and the second decoration layer 232 are the same as those of the decoration layer 130 of FIG. 4, the descriptions thereof are omitted. As detailed descriptions of the first adhesive layer 241 and the second adhesive layer 242 are the same as those of the adhesive layer 140 of FIG. 4, the descriptions thereof are omitted. As a detailed description of the second glass layer 220 is the same as that of the lower glass layer 110 of FIGS. 1 and 4, the description thereof is omitted.

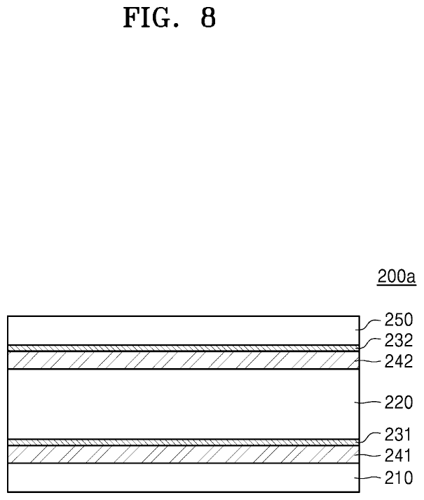

FIG. 8 is a cross-sectional view of a glass-glass laminate 200a according to one or more embodiments. In the following description, a difference between the glass-glass laminate 200 of FIG. 7 and the glass-glass laminate 200a of FIG. 8 is mainly described.

Referring to FIG. 8, the first decoration layer 231 may be located between the first adhesive layer 241 and the second glass layer 220. In other words, the glass-glass laminate 200a may include the first glass layer 210, the first adhesive layer 241, the first decoration layer 231, the second glass layer 220, the second adhesive layer 242, the second decoration layer 232, and the third glass layer 250, which are sequentially stacked. The first decoration layer 231 may be in direct contact with the second glass layer 220.

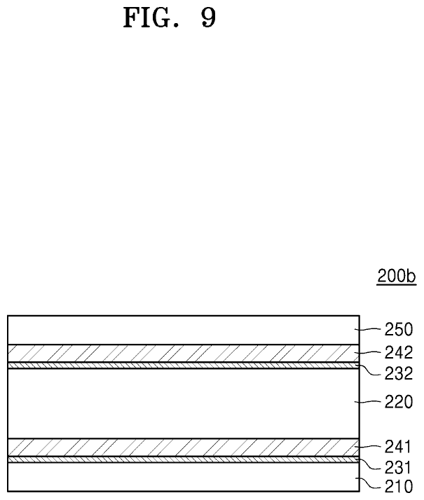

FIG. 9 is a cross-sectional view of a glass-glass laminate 200b according to one or more embodiments. In the following description, a difference between the glass-glass laminate 200 of FIG. 7 and the glass-glass laminate 200b of FIG. 9 is mainly described.

Referring to FIG. 9, the second decoration layer 232 may be located between the second adhesive layer 242 and the second glass layer 220. In other words, the glass-glass laminate 200b may include the first glass layer 210, the first decoration layer 231, the first adhesive layer 241, the second glass layer 220, the second decoration layer 232, the second adhesive layer 242, and the third glass layer 250, which are sequentially stacked. The second decoration layer 232 may be in direct contact with the second glass layer 220.

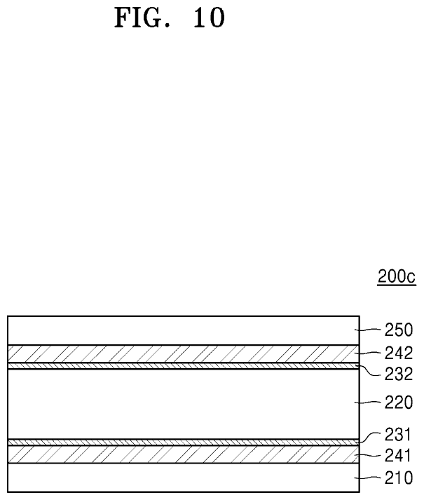

FIG. 10 is a cross-sectional view of a glass-glass laminate 200c according to one or more embodiments. In the following description, a difference between the glass-glass laminate 200 of FIG. 7 and the glass-glass laminate 200c of FIG. 10 is mainly described.

Referring to FIG. 10, the first decoration layer 231 may be located between the first adhesive layer 241 and the second glass layer 220, and the second decoration layer 232 may be located between the second adhesive layer 242 and the second glass layer 220. In other words, the glass-glass laminate 200c may include the first glass layer 210, the first adhesive layer 241, the first decoration layer 231, the second glass layer 220, the second decoration layer 232, the second adhesive layer 242, and the third glass layer 250, which are sequentially stacked. The first decoration layer 231 may be in direct contact with the second glass layer 220, and the second decoration layer 232 may be in direct contact with the second glass layer 220.

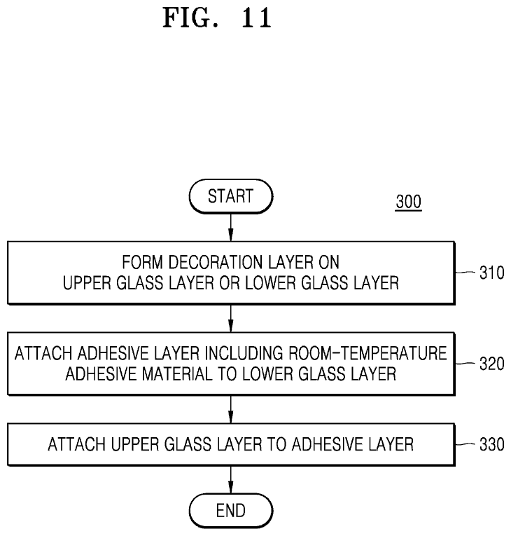

FIG. 11 is a flowchart of a method 300 of manufacturing a glass-glass laminate, according to one or more embodiments. FIGS. 12A to 12C are cross-sectional views showing the method 300 of FIG. 11.

Referring to FIGS. 11 and 12A, the decoration layer 130 may be formed on the lower glass layer 110 (310). In some embodiments, the decoration layer 130 may be printed on the lower glass layer 110. For example, the decoration layer 130 may be printed on the lower glass layer 110 by inkjet printing. The printing method is not limited to inkjet printing, and may include laser printing, silk screen printing, or slip decals. In some embodiments, the decoration layer 130 may be attached to the lower glass layer 110.

Referring to FIGS. 11 and 12B, the adhesive layer 140 including the room-temperature adhesive material may be attached to the lower glass layer 110 to allow the decoration layer 130 to be in contact with the adhesive layer 140 (320). The room-temperature adhesive material may include OCA or PSA. The OCA or PSA may be in the form of a film or tape.

Referring to FIGS. 11 and 12C, the upper glass layer 120 may be attached to the adhesive layer 140 (330). In some embodiments, a roller R may be used to attach the upper glass layer 120 to the adhesive layer 140. When the upper glass layer 120 is attached to the adhesive layer 140, the upper glass layer 120 may be bent.

In some embodiments, the attaching of the upper glass layer 120 to the adhesive layer 140 (330) may be performed at a slightly higher temperature, for example, about 35° C. to about 45° C., than room temperature, for example, about 20° C. to about 25° C. By attaching the upper glass layer 120 at a temperature that is slightly higher than room temperature, slight compression stress may be generated at room temperature in the upper glass layer 120 having a thermal expansion coefficient less than that of the lower glass layer 110. The slight compression stress may prevent propagation of cracks in the upper glass layer 120 that is thinner than the lower glass layer 110, thereby preventing damage to the glass-glass laminate. The temperature that is slightly higher than room temperature may be lower than the temperature to thermoset the PVB film according to the related art. Accordingly, the deformation of the decoration layer due to the high temperature process for thermosetting may be prevented, and bow of a glass-glass laminate due to excessive stress generated in the glass layers may be prevented.

The glass-glass laminate 100 of FIG. 4 may be manufactured by the manufacturing method 300 described with reference to FIG. 11 and FIGS. 12A to 12C. The manufacturing method 300 may be performed at room temperature and at a temperature, for example, about 35° C. to about 45° C., that is slightly high than room temperature, for example, about 20° C. to about 25° C. The manufacturing method 300 may not need a high temperature process for curing the adhesive layer 140. Accordingly, the deformation of the decoration layer 130 due to heat and the generation of excessive stress in the lower and upper glass layers 110 and 120 may be prevented.

Referring to FIG. 11 and FIG. 6, the decoration layer 130 may be formed on the upper glass layer 120 (310). The adhesive layer 140 including the room-temperature adhesive material may be attached to the lower glass layer 110 (320). Next, to allow the decoration layer 130 to be in contact with the adhesive layer 140, the upper glass layer 120 may be attached to the adhesive layer 140 (330). The glass-glass laminate 100b of FIG. 6 may be manufactured by the manufacturing method 300 described with reference to FIGS. 11 and 6.

Referring to FIG. 7, the first decoration layer 231 may be formed, for example, printed, on the first glass layer 210, and the second decoration layer 232 may be formed, for example, printed, on the third glass layer 250. Next, to allow the first decoration layer 231 to be in contact with the first adhesive layer 241, the first adhesive layer 241 including the room-temperature adhesive material may be attached to the second glass layer 220. Next, the first glass layer 210 may be attached to the first adhesive layer 241. Furthermore, the second adhesive layer 242 including the room-temperature adhesive material may be attached to the second glass layer 220. Next, to allow the second decoration layer 232 to be in contact with the second adhesive layer 242, the third glass layer 250 may be attached to the second adhesive layer 242. Accordingly, the glass-glass laminate 200 of FIG. 7 may be manufactured.

Referring to FIG. 8, the first decoration layer 231 may be formed, for example, printed, on the second glass layer 220, and the second decoration layer 232 may be formed, for example, printed, on the third glass layer 250. Next, to allow the first decoration layer 231 to be in contact with the first adhesive layer 241, the first adhesive layer 241 including the room-temperature adhesive material may be attached to the second glass layer 220. Next, the first glass layer 210 may be attached to the first adhesive layer 241. Furthermore, the second adhesive layer 242 including the room-temperature adhesive material may be attached to the second glass layer 220. Next, to allow the second decoration layer 232 to be in contact with the second adhesive layer 242, the third glass layer 250 may be attached to the second adhesive layer 242. Accordingly, the glass-glass laminate 200a of FIG. 8 may be manufactured.

Referring to FIG. 9, the first decoration layer 231 may be formed, for example, printed, on the first glass layer 210, and the second decoration layer 232 may be formed, for example, printed, on the second glass layer 220. Next, the first adhesive layer 241 including the room-temperature adhesive material may be attached to the second glass layer 220. Next, to allow the first decoration layer 231 to be in contact with the first adhesive layer 241, the first glass layer 210 may be attached to the first adhesive layer 241. Furthermore, to allow the second decoration layer 232 to be in contact with the second adhesive layer 242, the second adhesive layer 242 including the room-temperature adhesive material may be attached to the second glass layer 220. Next, the third glass layer 250 may be attached to the second adhesive layer 242. Accordingly, the glass-glass laminate 200b of FIG. 9 may be manufactured.

Referring to FIG. 10, the first decoration layer 231 and the second decoration layer 232 may be respectively formed, for example, printed, on two surfaces of the second glass layer 220 facing each other. Next, to allow the first decoration layer 231 to be in contact with the first adhesive layer 241, the first adhesive layer 241 including the room-temperature adhesive material may be attached to the second glass layer 220. Next, the first glass layer 210 may be attached to the first adhesive layer 241. Furthermore, to allow the second decoration layer 232 to be in contact with the second adhesive layer 242, the second adhesive layer 242 including the room-temperature adhesive material may be attached to the second glass layer 220. Next, the third glass layer 250 may be attached to the second adhesive layer 242. Accordingly, the glass-glass laminate 200c of FIG. 10 may be manufactured.

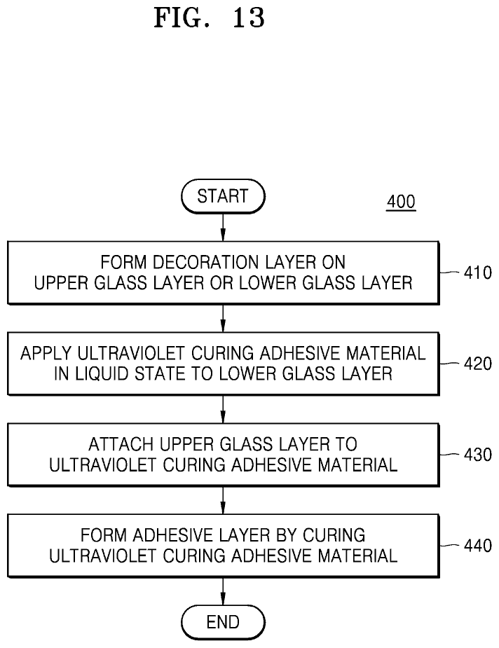

FIG. 13 is a flowchart of a method 400 of manufacturing a glass-glass laminate, according to one or more embodiments. FIGS. 14A to 14C are cross-sectional views showing the method 400 of FIG. 13.

Referring to FIGS. 13 and 14A, the decoration layer 130 may be formed on the lower glass layer 110 (410). In some embodiments, the decoration layer 130 may be printed on the lower glass layer 110. For example, the decoration layer 130 may be printed on the lower glass layer 110 by inkjet printing. In some embodiments, the decoration layer 130 may be attached to the lower glass layer 110.

Referring to FIGS. 13 and FIG. 14B, an ultraviolet curing adhesive material 140L in a liquid state may be applied to the lower glass layer 110, for example, the decoration layer 130 (420).

Referring to FIGS. 13 and 14C, the upper glass layer 120 may be attached to the ultraviolet curing adhesive material 140L (430). In some embodiments, the roller R may be used to attach the upper glass layer 120 to the ultraviolet curing adhesive material 140L. When the upper glass layer 120 is attached to the ultraviolet curing adhesive material 140L, the upper glass layer 120 may be bent.

In some embodiments, the attaching of the upper glass layer 120 to the ultraviolet curing adhesive material 140L (430) may be performed at a temperature, for example, about 35° C. to about 45° C., which is slightly higher than room temperature. By attaching the upper glass layer 120 at a temperature that is slightly higher than room temperature, slight compression stress may be generated at room temperature in the upper glass layer 120 having a thermal expansion coefficient less than that of the lower glass layer 110. The slight compression stress may prevent propagation of cracks in the upper glass layer 120 that is thinner than the lower glass layer 110, thereby preventing damage to the glass-glass laminate. However, when the upper glass layer 120 is attached at a too high temperature, excessive compression stress may be generated in the upper glass layer 120, and thus bow of a glass-glass laminate may be overly increased.

Referring to FIGS. 14C and 4, the adhesive layer 140 may be formed by curing the ultraviolet curing adhesive material 140L. For example, an ultraviolet ray may be irradiated to the ultraviolet curing adhesive material 140L for about 1 second to about 10 minutes, for example, for about 5 seconds to about 5 minutes or for about 10 seconds to about 1 minute.

The glass-glass laminate 100 of FIG. 4 may be manufactured according to the manufacturing method 400 described with reference to FIGS. 4, 13, and 14A to 14C. The manufacturing method 400 may not need a high temperature process to cure the adhesive layer 140. Accordingly, the deformation of the decoration layer 130 due to heat and the generation of excessive stress in the lower and upper glass layers 110 and 120 may be prevented.

Referring to FIGS. 13 and 6, the decoration layer 130 may be formed on the upper glass layer 120 (410). Next, an ultraviolet curing adhesive material in a liquid state may be applied to the lower glass layer 110 (420). To allow the decoration layer 130 to be in contact with the ultraviolet curing adhesive material, the upper glass layer 120 may be attached to the ultraviolet curing adhesive material (430). Next, the adhesive layer 140 may be formed by curing the ultraviolet curing adhesive material. The glass-glass laminate 100b of FIG. 6 may be manufactured according to the manufacturing method 400 described with reference to FIGS. 13 and 6.

Referring to FIG. 7, the first decoration layer 231 may be formed, for example, printed, on the first glass layer 210, and the second decoration layer 232 may be formed, for example, printed, on the third glass layer 250. Next, the ultraviolet curing adhesive material in a liquid state may be applied to the second glass layer 220. To allow the first decoration layer 231 to be in contact with the ultraviolet curing adhesive material, the first glass layer 210 may be attached to ultraviolet curing adhesive material. Next, by curing the ultraviolet curing adhesive material the first adhesive layer 241 may be formed. Furthermore, the ultraviolet curing adhesive material in a liquid state may be applied to the second glass layer 220. To allow the second decoration layer 232 to be in contact with the ultraviolet curing adhesive material, the third glass layer 250 may be attached to the ultraviolet curing adhesive material. Next, the second adhesive layer 242 may be formed by curing the ultraviolet curing adhesive material. Accordingly, the glass-glass laminate 200 of FIG. 7 may be manufactured.

Referring to FIG. 8, the first decoration layer 231 may be formed, for example, printed, on the second glass layer 220, and the second decoration layer 232 may be formed, for example, printed, on the third glass layer 250. Next, the ultraviolet curing adhesive material in a liquid state may be applied to the second glass layer 220, for example, the first decoration layer 231. The first glass layer 210 may be attached to ultraviolet curing adhesive material. Next, the first adhesive layer 241 may be formed by curing the ultraviolet curing adhesive material. Furthermore, the ultraviolet curing adhesive material in a liquid state may be applied to the second glass layer 220. To allow the second decoration layer 232 to be in contact with the ultraviolet curing adhesive material, the third glass layer 250 may be attached to the ultraviolet curing adhesive material. Next, the second adhesive layer 242 may be formed by curing the ultraviolet curing adhesive material. Accordingly, the glass-glass laminate 200a of FIG. 8 may be manufactured.

Referring to FIG. 9, the first decoration layer 231 may be formed, for example, printed, on the first glass layer 210, and the second decoration layer 232 may be formed, for example, printed, on the second glass layer 220. Next, the ultraviolet curing adhesive material in a liquid state may be applied to the second glass layer 220. To allow the first decoration layer 231 to in contact with the ultraviolet curing adhesive material, the first glass layer 210 may be attached to ultraviolet curing adhesive material. Next, the first adhesive layer 241 may be formed by curing the ultraviolet curing adhesive material. Furthermore, the ultraviolet curing adhesive material in a liquid state may be applied to the second glass layer 220, for example, the second decoration layer 232. The third glass layer 250 may be attached to the ultraviolet curing adhesive material. Next, the second adhesive layer 242 may be formed by curing the ultraviolet curing adhesive material. Accordingly, the glass-glass laminate 200b of FIG. 9 may be manufactured.

Referring to FIG. 10, the first decoration layer 231 and the second decoration layer 232 may be respectively formed, for example, printed, on two surfaces of the second glass layer 220 facing each other. Next, the ultraviolet curing adhesive material in a liquid state may be applied to the second glass layer 220, for example, the first decoration layer 231. The first glass layer 210 may be attached to the ultraviolet curing adhesive material. Next, the first adhesive layer 241 may be formed by curing the ultraviolet curing adhesive material. Furthermore, the ultraviolet curing adhesive material in a liquid state may be applied to the second glass layer 220, for example, the second decoration layer 232. The third glass layer 250 may be attached to the ultraviolet curing adhesive material. Next, the second adhesive layer 242 may be formed by curing the ultraviolet curing adhesive material. Accordingly, the glass-glass laminate 200c of FIG. 10 may be manufactured.

FIG. 15 is a flowchart of a method 500 of cutting a glass-glass laminate according to one or more embodiments. FIGS. 16A to 16C are cross-sectional views showing the method 500 of FIG. 15.

Referring to FIGS. 15 and 16A, the upper glass layer 120 may be scored (510). In other words, a first defect D1 may be formed on the upper glass layer 120.

Referring to FIGS. 15 and 16B, the lower glass layer 110 may be scored (520), that is, a second defect D2 is formed on the lower glass layer 110. The second defect D2 may be aligned with the first defect D1.

Referring to FIGS. 15 and 16C, the upper glass layer 120 and the lower glass layer 110 may be broken (530). Cutting the upper glass layer 120, the adhesive layer 140, and the lower glass layer 110 may be guided by the first defect D1 and the second defect D2. The adhesive layer 140 including the room-temperature adhesive material may be easily cut by the breaking, compared with a thermosetting material.

The glass-glass laminates 10, 100, and 100b of FIGS. 1, 4, and 6 may be easily cut according to the cutting method 500 described with reference to FIGS. 15 and 16A to 16C. Accordingly, the glass-glass laminates 10, 100, and 100b may be easily cut at work site by the cutting (scoring-breaking) method 500.

Referring to FIGS. 7 to 10, the third glass layer 250 may be scored. Furthermore, the first glass layer 210 may be scored. Next, the first glass layer 210, the second glass layer 220, and the third glass layer 250 may be broken. Accordingly, the glass-glass laminates 200, 200a, 200b, and 200c of FIGS. 7 to 10 may be easily cut. Accordingly, the glass-glass laminates 200, 200a, 200b, and 200c may be easily cut at work site by the cutting (scoring-breaking) method 500.

One or more embodiments provide a glass-glass laminate that is a glass laminate using glass as a substrate. In other words, the glass-glass laminate may include a lower glass layer, an adhesive layer, and an upper glass layer. The glass-glass laminate may have durability improved with respect to moisture/humidity changes and temperature changes, compared with a glass-nonglass laminate.

In some embodiments, the thickness of the upper glass layer may be less than the thickness of the lower glass layer, and the thermal expansion coefficient of the upper glass layer may be less than the thermal expansion coefficient of the lower glass layer. Accordingly, when the upper glass layer is boned to the lower glass layer at a temperature that is slightly higher than room temperature, slight compression stress may be generated in a relatively thin upper glass layer at room temperature. Accordingly, damage to the upper glass layer that is relatively thin may be prevented during processing, transport, or storage.

In some embodiments, the glass-glass laminate according to one or more embodiments may include a room-temperature adhesive material, instead of a thermosetting PVB film. Accordingly, as a high temperature process is unnecessary for thermosetting, deformation of the decoration layer due to heat and the generation of excessive stress in the glass layers may be prevented. Furthermore, the room-temperature adhesive material may facilitate cutting and processing of the glass-glass laminate after manufacturing. For example, a glass-glass laminate according to one or more embodiments may be easily cut by a scoring-breaking method. Accordingly, a glass-glass laminate according to one or more embodiments may be easily cut and processed at work site.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A glass-glass laminate comprising:
a lower glass layer;
an adhesive layer on the lower glass layer;
an upper glass layer on the adhesive layer; and
a decoration layer between the lower glass layer and the adhesive layer or between the upper glass layer and the adhesive layer,
wherein a thickness of the upper glass layer is less than a thickness of the lower glass layer, and
a thermal expansion coefficient of the upper glass layer is less than a thermal expansion coefficient of the lower glass layer.

2. The glass-glass laminate of claim 1, wherein the lower glass layer comprises soda lime glass, and the upper glass layer comprises at least one of borosilicate glass or aluminosilicate glass.

3. The glass-glass laminate of claim 1, wherein the thickness of the upper glass layer is 0.1 mm to 1.5 mm.

4. The glass-glass laminate of any of claim 1, wherein the adhesive layer comprises a room-temperature adhesive material.

5. The glass-glass laminate of claim 4, wherein an absolute value of bow of the upper glass layer is 0 μm to 500 μm.

6. The glass-glass laminate of claim 4, wherein the thickness of the lower glass layer is 0.1 mm to 17 mm.

7. The glass-glass laminate of claim 6, wherein the thickness of the lower glass layer is 0.4 mm to 12 mm.

8. The glass-glass laminate of claim 4, wherein the decoration layer is in direct contact with the lower glass layer or the upper glass layer.

9. The glass-glass laminate of any of claim 4, wherein the room-temperature adhesive material comprises a pressure sensitive adhesive (PSA) or an optically clear adhesive (OCA).

10. The glass-glass laminate of claim 9, wherein a thickness of the adhesive layer is 10 μm to 500 μm.

11. The glass-glass laminate of claim 10, wherein the thickness of the adhesive layer is 50 μm to 300 μm.

12. The glass-glass laminate of claim 4, wherein the room-temperature adhesive material comprises an ultraviolet curing material.

13. (canceled) A glass-glass laminate comprising:
a lower glass layer;
an adhesive layer on the lower glass layer;
an upper glass layer on the adhesive layer; and
a decoration layer between the lower glass layer and the adhesive layer or between the upper glass layer and the adhesive layer,
wherein the adhesive layer comprises a room-temperature adhesive material.

14. (canceled) A glass-glass laminate comprising:
a first glass layer;
a first adhesive layer on the first glass layer;
a second glass layer on the first adhesive layer;
a second adhesive layer on the second glass layer;
a third glass layer on the second adhesive layer;
a first decoration layer between the first glass layer and the first adhesive layer or between the second glass layer and the first adhesive layer; and
a second decoration layer between the second glass layer and the second adhesive layer or between the third glass layer and the second adhesive layer,
wherein the first adhesive layer and the second adhesive layer each comprise a room-temperature adhesive material.

15. A method of manufacturing a glass-glass laminate, the method comprising:
forming a decoration layer on an upper glass layer or a lower glass layer;
attaching, to the lower glass layer, an adhesive layer comprising a room-temperature adhesive material; and
attaching the upper glass layer to the adhesive layer.

16. The method of claim 15, wherein the attaching of the upper glass layer to the adhesive layer is performed at a temperature higher than room temperature.

17. The method of claim 15, wherein the forming of the decoration layer comprises printing the decoration layer on the upper glass layer or the lower glass layer.

18. The method of any of claim 15, wherein the room-temperature adhesive material comprises a pressure sensitive adhesive (PSA) or an optically clear adhesive (OCA).

19. A method of manufacturing a glass-glass laminate, the method comprising:
forming a decoration layer on an upper glass layer or a lower glass layer;
applying an ultraviolet curing adhesive material in a liquid state to the lower glass layer;
attaching the upper glass layer to the ultraviolet curing adhesive material; and
forming an adhesive layer by curing the ultraviolet curing adhesive material.

20. The method of claim 19, wherein the attaching of the upper glass layer to the ultraviolet curing adhesive material is performed at a temperature higher than room temperature.
